(19) United States
(12) Patent Application Publication
(10) Pub. No.: US 2025/0118046 A1
(43) Pub. Date: Apr. 10, 2025

(54) METHOD FOR TRAINING IMAGE CROPPING MODEL, METHOD FOR PROCESSING IMAGE, ELECTRONIC DEVICE AND STORAGE

(71) Applicant: Beijing Baidu Netcom Science Technology Co., Ltd., Beijing (CN)

(72) Inventors: Xiaoyun Han, Beijing (CN); Jingming Wang, Beijing (CN); Qiang Xie, Beijing (CN); Tao Li, Beijing (CN)

(21) Appl. No.: 18/985,445

(22) Filed: Dec. 18, 2024

(30) Foreign Application Priority Data
Aug. 13, 2024 (CN) 202411111989.3

(51) Int. Cl. G06V 10/32; G06V 10/42; G06V 10/74; G06V 10/766; G06V 10/77; G06V 10/774; G06V 40/10

(52) U.S. Cl. CPC G06V 10/32; G06V 10/42; G06V 10/761; G06V 10/7715; G06V 10/774; G06V 40/10; G06V 10/766

(57) ABSTRACT

Provided is a method for training an image cropping model, a method for processing an image, an electronic device and a storage medium, relating to the field of deep learning and image processing technology. The training method includes: obtaining sample data, wherein the sample data at least includes: a sample image, a first cropped image obtained by cropping the sample image in a first manner, and a second cropped image obtained by cropping the sample image in a second manner; determining a target loss function; and using at least the sample data and the target loss function to perform model training on a preset image cropping model to obtain a target image cropping model.

### CROSS-REFERENCE TO RELATED APPLICATIONS

The present application claims priority to Chinese Patent Application No. CN202411111989.3, filed with the China National Intellectual Property Administration on Aug. 13, 2024, the disclosure of which is hereby incorporated herein by reference in its entirety.

### TECHNICAL FIELD

The present disclosure relates to the field of computer processing technology, and in particular to the fields of artificial intelligence, big data, big model and other technologies.

### BACKGROUND

Information flow products will produce image content including pictures, text or videos, and the aspect ratios of these images are different. In order to ensure the aesthetic and consistency of images displayed in different scenarios on mobile terminals, it is usually necessary to automatically crop these images. However, the complexity of image content and different size requirements of different scenarios pose challenges to the cropping technology.

### SUMMARY

The present disclosure provides a method and an apparatus for training an image cropping model, a method and an apparatus for processing an image, a device and a storage medium.

According to an aspect of the present disclosure, provided is a method for training an image cropping model, including:
obtaining sample data, where the sample data at least includes: a sample image, a first cropped image obtained by cropping the sample image in a first manner, and a second cropped image obtained by cropping the sample image in a second manner;
determining a target loss function, where the target loss function is at least used to: constrain a difference between a first predicted attribute value of the first cropped image and a first theoretical attribute value of the first cropped image, and constrain a difference between a second predicted attribute value of the second cropped image and a second theoretical attribute value of the second cropped image; and
using at least the sample data and the target loss function to perform model training on a preset image cropping model to obtain a target image cropping model, where the first predicted attribute value and the second predicted attribute value are obtained using the preset image cropping model.

According to another aspect of the present disclosure, provided is an apparatus for training an image cropping model, including:
a first obtaining unit configured to obtain sample data, where the sample data at least includes: a sample image, a first cropped image obtained by cropping the sample image in a first manner, and a second cropped image obtained by cropping the sample image in a second manner; and
a training unit configured to determine a target loss function, where the target loss function is at least used to: constrain a difference between a first predicted attribute value of the first cropped image and a first theoretical attribute value of the first cropped image, and constrain a difference between a second predicted attribute value of the second cropped image and a second theoretical attribute value of the second cropped image; and configured to use at least the sample data and the target loss function to perform model training on a preset image cropping model to obtain a target image cropping model, where the first predicted attribute value and the second predicted attribute value are obtained using the preset image cropping model.

According to yet another aspect of the present disclosure, provided is a method for processing an image, including:
obtaining an image to be cropped; and
inputting at least the image to be cropped into a target image cropping model to obtain a target cropped image, where the target image cropping model is obtained based on the method for training the image cropping model described above.

According to yet another aspect of the present disclosure, provided is an apparatus for processing an image, including:
a second obtaining unit configured to obtain an image to be cropped; and
a model inference unit configured to input at least the image to be cropped into a target image cropping model to obtain a target cropped image, where the target image cropping model is obtained based on the method for training the image cropping model described above.

According to yet another aspect of the present disclosure, provided is an electronic device, including:
at least one processor; and
a memory connected in communication with the at least one processor;
where the memory stores an instruction executable by the at least one processor, and the instruction, when executed by the at least one processor, enables the at least one processor to execute the method of any embodiment of the present disclosure.

According to yet another aspect of the present disclosure, provided is a non-transitory computer-readable storage medium storing a computer instruction thereon, and the computer instruction is used to cause a computer to execute the method according to any one of the embodiments of the present disclosure.

According to yet another aspect of the present disclosure, provided is a computer program product including a computer program, and the computer program implements the method according to any one of the embodiments of the present disclosure, when executed by a processor.

In this way, the solution of the present disclosure can use the target loss function and the obtained sample data to train the preset image cropping model to obtain a model that can be used for image cropping (that is, the target image cropping model described above), so that the cropped image can effectively avoid problems such as character truncation and text truncation, thereby improving the cropping accuracy, providing support for meeting the multi-size requirements of different scenarios, and improving the user experience effectively.

It should be understood that the content described in this part is not intended to identify critical or essential features of embodiments of the present disclosure, nor is it used to limit the scope of the present disclosure. Other features of the present disclosure will be easily understood through the following description.

### BRIEF DESCRIPTION OF THE DRAWINGS

The accompanying drawings are used to better understand the present solution, and do not constitute a limitation to the present disclosure.

FIG. 1 is a first schematic flowchart of a method for training an image cropping model according to an embodiment of the present application;

FIG. 2 is a second schematic flowchart of a method for training an image cropping model according to an embodiment of the present application;

FIG. 3 is a schematic diagram of a model training scenario of a preset image cropping model according to an embodiment of the present application;

FIG. 4 is a schematic diagram of a scenario of the preset image cropping model according to an embodiment of the present application;

FIG. 5 is a schematic flowchart of the method for training the image cropping model in an example according to an embodiment of the present application;

FIG. 6 is a schematic diagram of a process of automatically constructing sample data according to an embodiment of the present application;

FIG. 7 is a structural schematic diagram of an image cropping system according to an embodiment of the present application;

FIG. 8 is a schematic flowchart of a method for processing an image according to an embodiment of the present application;

FIG. 9 is a structural schematic diagram of an apparatus for training an image cropping model according to an embodiment of the present application;

FIG. 10 is a structural schematic diagram of an apparatus for processing an image according to an embodiment of the present application; and

FIG. 11 is a block diagram of an electronic device used to implement the method for training the image cropping model or the method for processing the image according to an embodiment of the present disclosure.

### DETAILED DESCRIPTION

Hereinafter, descriptions to exemplary embodiments of the present disclosure are made with reference to accompanying drawings, include various details of embodiments of the present disclosure to facilitate understanding, and should be considered as merely exemplary. Therefore, those having ordinary skill in the art should realize, various changes and modifications may be made to the embodiments described herein, without departing from the scope of the present disclosure. Likewise, for clarity and conciseness, descriptions of well-known functions and structures are omitted in the following descriptions.

The term “and/or” herein only describes an association relation of associated objects, which indicates that there may be three kinds of relations, for example, A and/or B may indicate that only A exists, or both A and B exist, or only B exists. The term “at least one” herein indicates any one of many items, or any combination of at least two of the many items, for example, at least one of A, B or C may indicate any one or more elements selected from a set of A, B and C. The terms “first” and “second” herein indicate a plurality of similar technical terms and distinguish them from each other, but do not limit an order of them or limit that there are only two items, for example, a first feature and a second feature indicate two types of features/two features, a quantity of the first feature may be one or more, and a quantity of the second feature may also be one or more.

In addition, in order to better illustrate the present disclosure, numerous specific details are given in the following specific implementations. Those having ordinary skill in the art should understand that the present disclosure may be performed without certain specific details. In some examples, methods, means, elements and circuits well known to those having ordinary skill in the art are not described in detail, in order to highlight the subject matter of the present disclosure.

The related technologies of the embodiments of the present disclosure will be illustrated below. The following related technologies are optional solutions that can be arbitrarily combined with the technical solutions of the embodiments of the present disclosure, and all belong to the protection scope of the embodiments of the present disclosure.

The solution of the present disclosure proposes a method for training an image cropping model, to improve the accuracy of image cropping, effectively ensure the aesthetic and consistency of images when displayed in different scenarios on a mobile terminal, and thus improve the user experience.

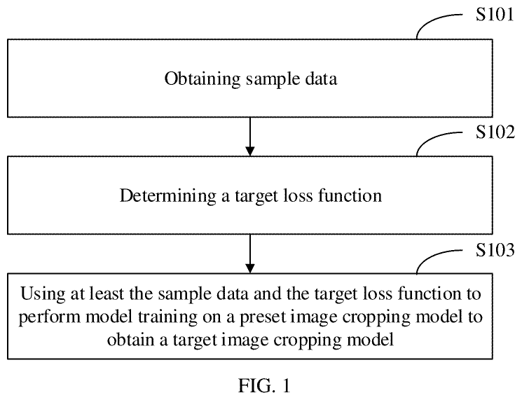

Specifically, FIG. 1 is a first schematic flowchart of a method for training an image cropping model according to an embodiment of the present application. The method is optionally applied to electronic devices, such as personal computers, servers, server clusters and other electronic devices.

Further, the method includes at least a part of the following content. As shown in FIG. 1, the method includes the following steps.

Step S101: sample data is obtained.

Here, the sample data at least includes: a sample image, a first cropped image obtained by cropping the sample image in a first manner, and a second cropped image obtained by cropping the sample image in a second manner.

For instance, in an example, M groups of sample data may be obtained; and accordingly, each sample data in the M groups of sample data at least includes: a sample image, N1 first cropped images obtained by cropping the sample image in the first manner, and N2 second cropped images obtained by cropping the sample image in the second manner. Here, M, N1 and N2 are all natural numbers greater than or equal to 1.

Further, M is a natural number greater than or equal to 2. N1 and N2 are natural numbers greater than or equal to 1. Here, it can be understood that the values of N1 and N2 may be the same or different, which are not limited in the solution of the present disclosure.

It should be noted that the first manner and the second manner described above are different cropping manners, and for example, may specifically refer to cropping the sample image from different directions. Further, in an example, the sample data in the solution of the present disclosure may also include a plurality of cropped images obtained by cropping the sample image in other cropping manners. In other words, the solution of the present disclosure does not limit the quantity of cropping manners used in the sample data.

Further, in an example, the sample data may also include a theoretical attribute value of each first cropped image and a theoretical attribute value of each second cropped image, thereby providing label data for subsequent model training.

It should be noted that the sample image in the example may be specifically understood as an initial image that has not been cropped or marked with a cropping box; and correspondingly, the cropped image (e.g., the first cropped image or the second cropped image) may be understood as an image obtained after the initial image is cropped or marked with the cropping box; further, the theoretical attribute value of the cropped image (e.g., the first cropped image or the second cropped image) may be specifically an attribute value obtained after evaluating this cropped image (e.g., the first cropped image or the second cropped image) based on the optimal cropped image of the sample image. For example, in an example, the Intersection Over Union (IOU) of the cropped image (e.g., the first cropped image or the second cropped image) is calculated based on the optimal cropped image of the sample image. At this time, the calculated IOU of the cropped image may be used as the theoretical attribute value of the cropped image.

Further, in an example, the attribute value described above may be specifically an aesthetic score. At this time, the predicted attribute value described in the solution of the present disclosure may be specifically a predicted aesthetic score, and correspondingly, the theoretical attribute value may be specifically a theoretical aesthetic score.

For instance, in an example, an i-th (i is an integer greater than 0 and less than or equal to M) group of sample data among the M groups of sample data may specifically include a sample image i, N1 first cropped images obtained after cropping the sample image i in the first manner, theoretical aesthetic scores of the first cropped images, N2 second cropped images obtained after cropping the sample image i in the second manner, and theoretical aesthetic scores of the second cropped images. In this way, rich and high-quality training samples are effectively obtained, laying the foundation for the subsequent improvement of the training effect of the cropping model.

Step S102: a target loss function is determined.

Here, the target loss function is at least used to: constrain (or represent) a difference between a first predicted attribute value (e.g., a first predicted aesthetic score) of the first cropped image and a first theoretical attribute value (e.g., a first theoretical aesthetic score) of the first cropped image, and constrain a difference between a second predicted attribute value (e.g., a second predicted aesthetic score) of the second cropped image and a second theoretical attribute value (e.g., a second theoretical aesthetic score) of the second cropped image.

Step S103: the sample data and the target loss function are at least used to perform model training on a preset image cropping model to obtain a target image cropping model.

Here, the first predicted attribute value and the second predicted attribute value are obtained using the preset image cropping model.

For example, in an example, with respect to obtaining the M groups of sample data, the preset image cropping model may be trained using at least the M groups of sample data and the determined target loss function, to obtain the target image cropping model.

It can be understood that, in an example, the target loss function is used to constrain (or represent) the difference between the first predicted attribute value of the first cropped image and the first theoretical attribute value of the first cropped image; or, in another example, the target loss function is used to constrain (or represent) the difference between the second predicted attribute value of the second cropped image and the second theoretical attribute value of the second cropped image; or, in yet another example, the target loss function is used to constrain (or represent) the difference between the first predicted attribute value of the first cropped image and the first theoretical attribute value of the first cropped image, and constrain (or represent) the difference between the second predicted attribute value of the second cropped image and the second theoretical attribute value of the second cropped image. In this way, technical support is provided for the trained model to have a better cropping effect.

For example, in an example, the difference between the predicted attribute value (e.g., the predicted aesthetic score) of a cropped image and the theoretical attribute value (e.g., the theoretical aesthetic score) of the cropped image may be calculated by a regression loss function; and at this time, the target loss function (denoted as Loss) in the example may be obtained based on the regression loss function of the first cropped image (denoted as as L_{1-regression}) and the regression loss function of the second cropped image (denoted as L_{2-regression}). For example, in an example, the target loss function is a sum of the regression loss function of the first cropped image and the regression loss function of the second cropped image, that is, Loss=L_{1-regression}+L_{2-regression}.

In this way, the solution of the present disclosure can use the target loss function and the obtained sample data to train the preset image cropping model to obtain a model that can be used for image cropping (that is, the target image cropping model described above), so that the cropped image can effectively avoid problems such as character truncation and text truncation, improving the cropping accuracy, providing support for meeting the multi-size requirements of different scenarios, and improving the user experience effectively.

In a specific example, the first manner and the second manner described above are different cropping manners, such as: horizontal cropping manner and vertical cropping manner based on sliding window and limited threshold scaling, etc., which is not specifically limited in the solution of the present disclosure. In this way, technical support is provided for the trained model to have a better cropping effect.

Further, in an example, the first cropped image is obtained by horizontally cropping the sample image; and/or, the second cropped image is obtained by vertically cropping the sample image.

For example, in an example, the first manner is the horizontal cropping manner, and the second manner is the vertical cropping manner. At this time, the first cropped image is a horizontal cropped image obtained by horizontally cropping the sample image, and correspondingly, the second cropped image is a vertical cropped image obtained by vertically cropping the sample image.

It can be understood that the above cropping manners are merely exemplary description. In actual applications, the cropping manners can be set based on specific scene requirements, and are not limited in the solution of the present disclosure.

In this way, the solution of the present disclosure can obtain a plurality of kinds of cropped images (such as the first cropped image and the second cropped image) in different cropping manners, thereby improving the richness of samples required for model training, so that the model can learn diverse features, and then has the stronger generalization capability and is applicable to different application scenarios, thereby further improving the user experience.

In a specific example of the solution of the present disclosure, in order to further improve the model training effect, the target loss function is further used for at least one of:
when the sample data includes two or more first cropped images (that is, two or more first cropped images are obtained after cropping the sample image in the first manner), constraining (also referred to as representing) the similarity between a first actual sorting result and a first theoretical sorting result; where the first actual sorting result is a result after sorting all the first cropped images (i.e., the N1 first cropped images mentioned above) according to numerical values of first predicted attribute values of the first cropped images, and the first theoretical sorting result is a result after sorting all the first cropped images (i.e., the N1 first cropped images mentioned above) according to numerical values of first theoretical attribute values of the first cropped images; and
when the sample data includes two or more second cropped images (that is, two or more second cropped images are obtained after cropping the sample image in the second manner), constraining (also referred to as representing) the similarity between a second actual sorting result and a second theoretical sorting result; where the second actual sorting result is a result after sorting all the second cropped images (that is, the N2 second cropped images mentioned above) according to numerical values of second predicted attribute values of the second cropped images, and the second theoretical sorting result is a result after sorting all the second cropped images (that is, the N2 second cropped images mentioned above) according to numerical values of second theoretical attribute values of the second cropped images.

For example, continue to take the obtained M groups of sample data as an example. In an example, the target loss function is used to:
constrain the difference between the first predicted attribute value of the first cropped image and the first theoretical attribute value of the first cropped image, constrain the difference between the second predicted attribute value of the second cropped image and the second theoretical attribute value of the second cropped image, and constrain the similarity between the first actual sorting result and the first theoretical sorting result.

Alternatively, in another example, the target loss function is used to:
constrain the difference between the first predicted attribute value of the first cropped image and the first theoretical attribute value of the first cropped image, constrain the difference between the second predicted attribute value of the second cropped image and the second theoretical attribute value of the second cropped image, and constrain the similarity between the second actual sorting result and the second theoretical sorting result.

Alternatively, in yet another example, the target loss function is used to:
constrain the difference between the first predicted attribute value of the first cropped image and the first theoretical attribute value of the first cropped image, constrain the difference between the second predicted attribute value of the second cropped image and the second theoretical attribute value of the second cropped image, constrain the similarity between the first actual sorting result and the first theoretical sorting result, and constrain the similarity between the second actual sorting result and the second theoretical sorting result.

It should be pointed out that the similarities between the actual sorting results and the theoretical sorting results of the cropped images contained in the sample data may be calculated based on a sorting loss function; and at this time, the target loss function in the example may also be obtained based on the sorting loss function of the first cropped image (denoted as L_{1-sorting}) and/or the sorting loss function of the second cropped image (denoted as L_{2-sorting}).

For example, in an example, the target loss function may be obtained based on at least one or more of the following loss functions:
the regression loss function of the first cropped image (L_{1-regression});
the sorting loss function of the first cropped image (L_{1-sorting});
the regression loss function of the second cropped image (L_{2-regression}); and
the sorting loss function of the second cropped image (L_{2-sorting}).

Further, in an example, the overall loss function of the first cropped image (denoted as L₁₋ₒᵥₑᵣₐₗₗ) may be obtained based on the regression loss function of the first cropped image and the sorting loss function of the first cropped image, and the overall loss function of the second cropped image (denoted as L₂₋ₒᵥₑᵣₐₗₗ) may be obtained based on the regression loss function of the second cropped image and the sorting loss function of the second cropped image.

At this time, the target loss function may be obtained based on the overall loss function of the first cropped image and the overall loss function of the second cropped image, for example, Loss=L₁₋ₒᵥₑᵣₐₗₗ+L₂₋ₒᵥₑᵣₐₗₗ. Further, in an example, the overall loss function of the first cropped image is L₁₋ₒᵥₑᵣₐₗₗ=L_{1-regression}+L_{1-sorting}, and the overall loss function of the second cropped image is L₂₋ₒᵥₑᵣₐₗₗ=L_{2-regression}+L_{2-sorting}. At this time, the target loss function is Loss=L_{1-regression}+L_{1-sorting}+L_{2-regression}+L_{2-sorting}.

It can be understood that weights may also be added in the target loss function based on actual requirements, to adapt to different cropping requirements. For example, the target loss function is Loss=a₁L_{1-regression}+a₂L_{1-sorting}+b₁L_{2-regression}+b₂L_{2-sorting}. Here, a₁, a₂, b₁ and b₂ may be determined based on actual requirements.

Thus, the solution of the present disclosure provides one or more design schemes for the target loss function, so that the parameters of the preset image cropping model can be effectively optimized, thereby improving the cropping accuracy of the model. Moreover, the constructed loss function can adapt to different types of task requirements, so that the trained model can crop images that meet the size requirements of specific scenarios, thereby improving the user experience.

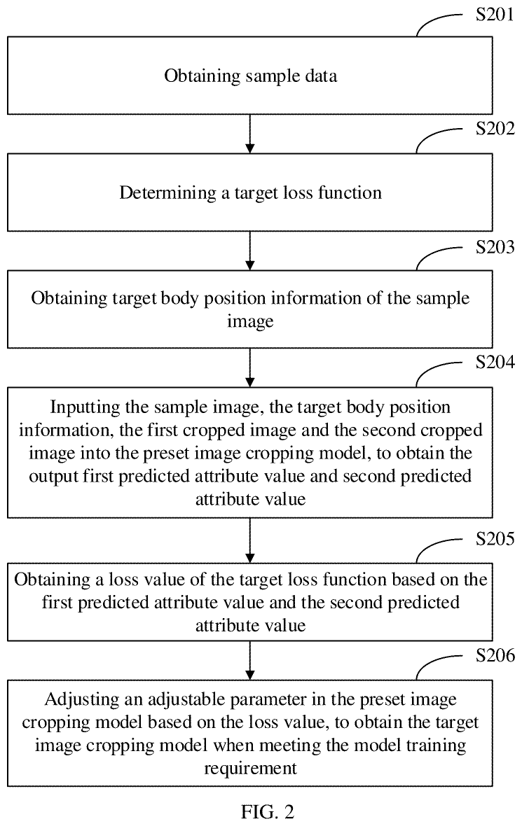

Specifically, FIG. 2 is a second schematic flowchart of a method for training an image cropping model according to an embodiment of the present application. The method is optionally applied to electronic devices, such as personal computers, servers, server clusters and other electronic devices. It can be understood that the relevant content of the method shown in FIG. 1 described above may also be applied to this example, and the relevant content will not be repeated in this example.

Further, the method includes at least a part of the following content. As shown in FIG. 2, the method includes the following steps.

Step S201: sample data is obtained.

Here, the sample data at least includes: a sample image, a first cropped image obtained by cropping the sample image in a first manner, and a second cropped image obtained by cropping the sample image in a second manner.

Here, the relevant content about the sample data can refer to the above examples, and will not be repeated here.

Step S202: a target loss function is determined.

Here, the target loss function is at least used to: constrain (or represent) a difference between a first predicted attribute value of the first cropped image and a first theoretical attribute value of the first cropped image, and constrain a difference between a second predicted attribute value of the second cropped image and a second theoretical attribute value of the second cropped image.

Here, the relevant content about the target loss function can refer to the above examples, and will not be repeated here.

Step S203: target body position information of the sample image is obtained.

In an example, the above step of obtaining the target body position information of the sample image (for example, the above step S203) may specifically include: inputting the sample image into a target detection model to obtain the output target body position information. Here, the target detection model is used to detect the position of the target object in the input image.

That is to say, in the example, the target detection model can be used to detect the position of the target body in the sample image to obtain specific position information of each target body in the sample image (that is, the target body position information described above), so that the model can extract effective features based on the target body position information for use in evaluating the cropped image, thereby providing strong support for improving the cropping accuracy of the model.

Step S204: the sample image, the target body position information, the first cropped image and the second cropped image are input into the preset image cropping model, to obtain the output first predicted attribute value and second predicted attribute value.

For example, continuing to take the obtained M groups of sample data as an example, the sample image, the target body position information of the sample image, the N1 first cropped images and the N2 second cropped images contained in the sample image are input into the preset image cropping model to obtain the first predicted attribute value of each first cropped image and the second predicted attribute value of each second cropped image.

Step S205: a loss value of the target loss function is obtained based on the first predicted attribute value and the second predicted attribute value.

For example, in an example, the loss value of the target loss function is obtained based on the obtained first predicted attribute value of each first cropped image and the obtained second predicted attribute value of each second cropped image.

Step S206: an adjustable parameter in the preset image cropping model is adjusted based on the loss value, to obtain the target image cropping model when meeting the model training requirement.

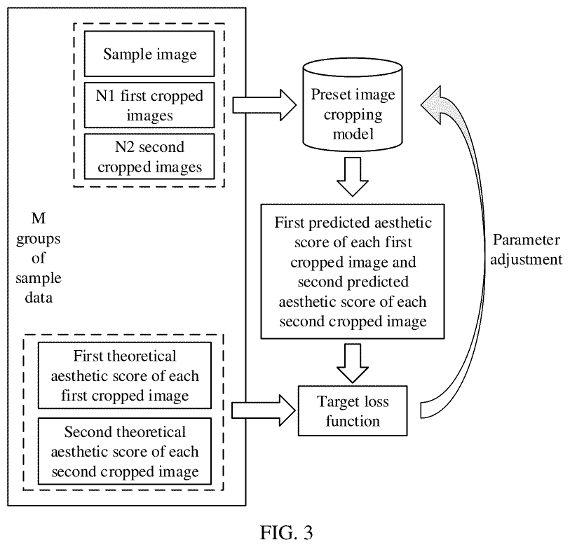

For instance, in an example, continuing to take the obtained M groups of sample data as an example, as shown in FIG. 3, firstly the sample image, the target body position information of the sample image, the N1 first cropped images and the N2 second cropped images contained in the sample image are input into the preset image cropping model to obtain the first predicted aesthetic score of each first cropped image and the second predicted aesthetic score of each second cropped image; secondly the loss value of the target loss function is obtained based on the difference between the first predicted aesthetic score and first theoretical aesthetic score of each first cropped image as well as the difference between the second predicted aesthetic score and second theoretical aesthetic score of each second cropped image; and finally, when the loss value of the target loss function or the quantity of iterations does not meet the model training requirement, the adjustable parameter in the preset image cropping model is adjusted based on the loss value of the target loss function. This cycle is repeated until the loss value of the target loss function meets the model training requirement. In this way, the trained target image cropping model can be obtained.

Thus, the solution of the present disclosure provides a scheme for training the preset image cropping model to efficiently train the target image cropping model. Moreover, the cropped image obtained using the trained target image cropping model can effectively avoid problems such as character truncation and text truncation, improving the cropping accuracy effectively and thus improving the user experience effectively. Also, the target image cropping model in the solution of the present disclosure can also crop images in various sizes, meeting the multi-size requirements of different scenarios effectively, and thus improving the user experience.

Here, it should be noted that the preset image cropping model mentioned above may be specifically a neural network model for cropping images, or may be specifically a large model for cropping images, etc., which is not limited in the solution of the present disclosure.

Further, in a specific example of the solution of the present disclosure, the preset image cropping model includes at least a first branch and a second branch.

For instance, in an example, the first branch may be at least used to process a global feature of the sample image and a global feature of the first cropped image to obtain the first predicted attribute value of the first cropped image; and further, in another example, the second branch may be at least used to process the global feature of the sample image and a global feature of the second cropped image to obtain the second predicted attribute value of the second cropped image.

Thus, the solution of the present disclosure provides a specific scheme for the model structure of the preset image cropping model, thereby improving the ability to learn different cropping manners, possessing the better interpretation capability, and then improving the accuracy of model cropping. Moreover, for size requirements of specific scenarios, the solution of the present disclosure can crop high-quality cropped images, thereby improving the user experience.

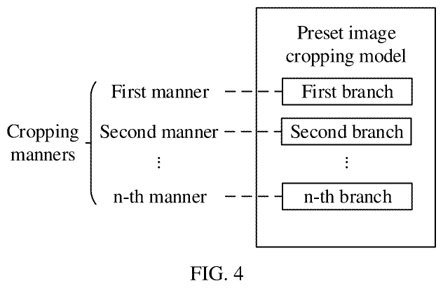

Here, the first branch and the second branch included in the preset image cropping model described above are merely exemplary description. In addition, when the sample data further includes a plurality of cropped images obtained by cropping the sample image in other cropping manners, the preset image cropping model may further include branches corresponding to other cropping manners. For example, in an example, the quantity of branches in the preset image cropping model is related to the quantity of cropping manners. For example, as shown in FIG. 4, the quantity of branches in the preset image cropping model is the same as the quantity of cropping manners, that is, each of n (a positive integer greater than or equal to 2) branches included in the preset image cropping model corresponds to one cropping manner.

Here, the quantity of branches included in the preset image cropping model may be set according to actual scenario requirements, and is not specifically limited in the solution of the present disclosure.

Further, in an example, the first branch at least includes a first feature alignment module, a first Graph Attention Network (GAT) and a first Multilayer Perceptron (MLP). Further, the first feature alignment module is mainly configured to perform feature alignment on the global feature of the sample image and the global feature of the first cropped image. For example, in an example, the feature alignment may be performed on the global feature of the sample image and the global feature of the first cropped image by using the Region of Interest align (RoI Align), Region of Difference align (RoD Align) and other technologies. Further, the first GAT is mainly configured to perform attention processing on the feature of the sample image and the feature of the first cropped image after feature alignment; and the first MLP is mainly configured to perform feature matching on the feature of the sample image and the feature of the first cropped image after attention processing, to obtain the first predicted attribute value of the first cropped image.

Alternatively, in another example, the second branch at least includes a second feature alignment module, a second GAT and a second MLP; and further, the second feature alignment module is mainly configured to perform feature alignment on the global feature of the sample image and the global feature of the second cropped image. For example, in an example, the feature alignment may be performed on the global feature of the sample image and the global feature of each second cropped image by using the RoI Align and RoD Align technologies. Further, the second GAT is mainly configured to perform attention processing on the feature of the sample image and the feature of the second cropped image after feature alignment; and the second MLP is mainly configured to perform feature matching on the feature of the sample image and the feature of the second cropped image after attention processing, to obtain the second predicted attribute value of the second cropped image.

Alternatively, in yet another example, the first branch at least includes a first feature alignment module, a first GAT and a first MLP, and the second branch at least includes a second feature alignment module, a second GAT and a second MLP.

Thus, the solution of the present disclosure can utilize different processing branches to process the cropped images (such as the first cropped image or the second cropped image) obtained in different cropping manners to obtain the predicted attribute value of each cropped image, so that the ability of the model to learn the cropped images obtained in different cropping manners can be effectively improved, thereby laying the foundation for meeting the cropping requirements of different scenarios and then improving the cropping accuracy of the model effectively.

Further, in a specific example, the preset image cropping model further includes a shared backbone network.

Here, the output of the shared backbone network may serve as inputs of the first branch and the second branch; and further, the shared backbone network is configured to: obtain the global feature of the sample image based on the input sample image and the target body position information of the sample image; obtain the global feature of the first cropped image based on the input first cropped image; and obtain the global feature of the second cropped image based on the input second cropped image.

For example, in an example, the shared backbone network, such as Residual Network (ResNet), may perform feature extraction on a target body in the sample image according to the target body position information of the sample image, to obtain the global feature of the sample image; and moreover, the residual network further performs feature extraction on the input first cropped image to obtain the global feature of the first cropped image, and performs feature extraction on the input second cropped image to obtain the global feature of the second cropped image.

It should be noted that, in addition to the residual network, the shared backbone network may be specifically a pre-trained network such as Mobile Network V2 (MobileNetV2), Efficient Network (EfficientNet), Swin Transformer, etc., which is not specifically limited in the solution of the present disclosure.

Thus, the solution of the present disclosure can utilize the shared backbone network to extract effective features from the input image and input the extracted effective features into the corresponding branches respectively, thereby laying the foundation for subsequently improving the evaluation efficiency of the cropped image in each branch.

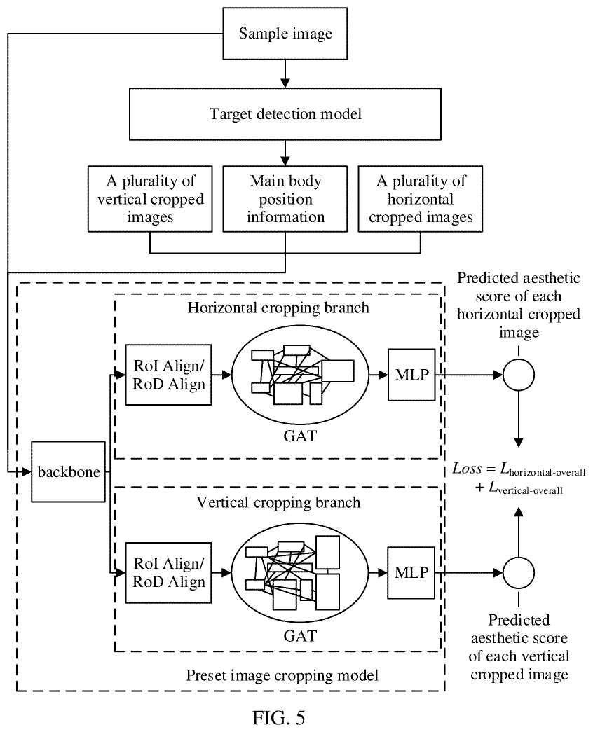

The solution of the present disclosure will be further described in detail below with reference to specific examples. Specifically, FIG. 5 is a schematic flowchart of a method for training an end-to-end image cropping model based on deep learning in a specific example according to an embodiment of the present disclosure. As shown in FIG. 5, the method for training the model may mainly include the following steps.

Step S501: a sample image is input into a target detection model to detect a main body (corresponding to the target body described above) of the sample image, to obtain the main body position information (corresponding to the target body position information described above).

Step S502: inputting the sample image, the main body position information, a plurality of horizontal cropped images (for example, corresponding to the plurality of first cropped images described above) and a plurality of vertical cropped images (for example, corresponding to the plurality of second cropped images described above) into a backbone (corresponding to the shared backbone network described above) layer in a preset image cropping model to extract the global feature of each image.

Here, in an example, before each horizontal cropped image and each vertical cropped image are input into the preset image cropping model, each horizontal cropped image and each vertical cropped image may be preprocessed based on actual requirements, which is not specifically limited in the solution of the present disclosure.

Further, the backbone layer may be specifically a Residual Network (ResNet), or may be specifically a pre-trained network such as Mobile Network V2 (MobileNetV2), Efficient Network (EfficientNet), Swin Transformer, etc., which is not specifically limited in the solution of the present disclosure.

Step S503: the global feature of the sample image and the global features of the horizontal cropped images are input into a feature alignment module (for example, corresponding to the first feature alignment module described above) in the horizontal cropping branch (for example, corresponding to the first branch described above) of the preset image cropping model to perform feature alignment on the global feature of the sample image and the global features of the horizontal cropped images; and the global feature of the sample image and the global features of the vertical cropped images are input into a feature alignment module (for example, corresponding to the second feature alignment module described above) in the vertical cropping branch (for example, corresponding to the second branch described above) of the preset image cropping model to perform feature alignment on the global feature of the sample image and the global features of the vertical cropping images.

Here, both the feature alignment module in the horizontal cropping branch and the feature alignment module in the vertical cropping branch may use the RoI Align and RoD Align technologies for feature alignment. Further, other feature alignment technologies may also be used, and the solution of the present disclosure does not impose any specific restriction on the specific technology used in the feature alignment modules.

Step S504: the features of the horizontal cropped images and the feature of the sample image after feature alignment are input into the GAT in the horizontal cropping branch (corresponding to the first GAT described above) to perform attention processing and obtain the features of the horizontal cropped images and the feature of the sample image after attention processing; and the features of the vertical cropped images and the feature of the sample image after feature alignment are input into the GAT in the vertical cropping branch (corresponding to the second GAT described above) to perform attention processing and obtain the features of the vertical cropped images and the feature of the sample image after attention processing.

Step S505: the features of the horizontal cropped image and the feature of the sample image after attention processing are input into the MLP network in the horizontal cropping branch (corresponding to the first MLP network described above) to obtain the predicted aesthetic score of each horizontal cropped image; and the features of the vertical cropped image and the feature of the sample image after attention processing are input into the MLP network in the vertical cropping branch (corresponding to the second MLP described above) to obtain the predicted aesthetic score of each vertical cropped image.

Step S506: a loss value Loss (hereinafter referred to as the total loss value) of the total loss function (corresponding to the target loss function described above) is determined, and the total loss value is used to adjust the adjustable parameter in the preset image cropping model to obtain the trained preset image cropping model (corresponding to the target image cropping model described above).

Here, in an example, the total loss value may specifically include the sum of the overall loss value of the horizontal cropped image (denoted as L_{horizontal-overall}) and the overall loss value of the vertical cropped image (denoted as L_{vertical-overall}); the overall loss value of the horizontal cropped image is the sum of the regression loss value (denoted as L_{horizontal-regression}) and the sorting loss value (denoted as L_{horizontal-sorting}) of the horizontal cropped image; and the overall loss value of the vertical cropped image is the sum of the regression loss value (denoted as L_{vertical-regression}) and the sorting loss value (denoted as L_{vertical-sorting}) of the vertical cropped image.

Further, in an example, the regression loss value of the horizontal cropped image may be obtained based on the predicted aesthetic score and the theoretical aesthetic score of the horizontal cropped image; and similarly, the regression loss value of the vertical cropped image may be obtained based on the predicted aesthetic score and the theoretical aesthetic score of the vertical cropped image.

Further, sorting is performed based on the predicted aesthetic score of each horizontal cropped image to obtain a sorting result of the horizontal cropped image (corresponding to the first actual sorting result described above), and the sorting loss value of the horizontal cropped image is obtained based on the similarity between the sorting result and a theoretical sorting result (which is a sorting result obtained based on the theoretical score, i.e., corresponding to the first theoretical sorting result described above) of the horizontal cropped image; and similarly, sorting is performed based on the predicted aesthetic score of each vertical cropped image to obtain a sorting result of the vertical cropped image (corresponding to the second actual sorting result described above), and the sorting loss value of the vertical cropped image is obtained based on the similarity between the sorting result and a theoretical sorting result (which is a sorting result obtained based on the theoretical score, i.e., corresponding to the second theoretical sorting result described above) of the vertical cropped image.

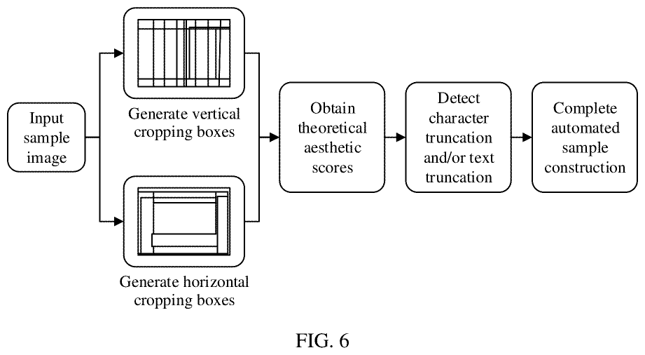

Further, in a specific example, the sample data may be constructed in the following manner; and specifically, as shown in FIG. 6, the solution of the present disclosure provides a method for automatically constructing training samples, and includes the following specific steps.

Step S601: a plurality of first cropping boxes (such as horizontal cropping boxes) are generated on the sample image by using a sliding window and a limited threshold, to obtain a plurality of first cropped images (such as a plurality of horizontal cropped images); and similarly, a plurality of second cropping boxes (such as vertical cropping boxes) are generated on the sample image, to obtain a plurality of second cropped images (such as a plurality of vertical cropped images).

Step S602: theoretical aesthetic scores of the first cropped images and the second cropped images generated based on the sample image are obtained, to construct a sample data set.

For example, the Intersection Over Union (IOU) of each cropping box (or each cropped image) may be calculated as the theoretical aesthetic score of each cropping box (or each cropped image).

Further, in order to further improve the cropping effect, the solution of the present disclosure can also introduce face truncation detection and/or text truncation detection, and set the theoretical aesthetic score of the cropped image with truncation to a negative score. In this way, the score ranking of the candidate boxes can be effectively reduced during model training, so that the model has the ability to avoid character truncation and text truncation.

Further, in practical applications, the character truncation or text truncation may appear in the cropped images produced using the traditional cropping technology described above (such samples may also be called truncated samples). In this case, the cropped images without truncation (that is, high-quality samples) may be used as sample data, and a small quantity of truncated samples may be manually annotated and then used as sample data, thereby improving the quality of the sample data set effectively.

In this way, the solution of the present disclosure can use thousands of truncated samples manually annotated and tens of thousands of high-quality samples automatically constructed to constitute a large amount of sample data for model training, so that rich and high-quality sample data can be obtained quickly, providing strong support for the trained model to have a better cropping effect.

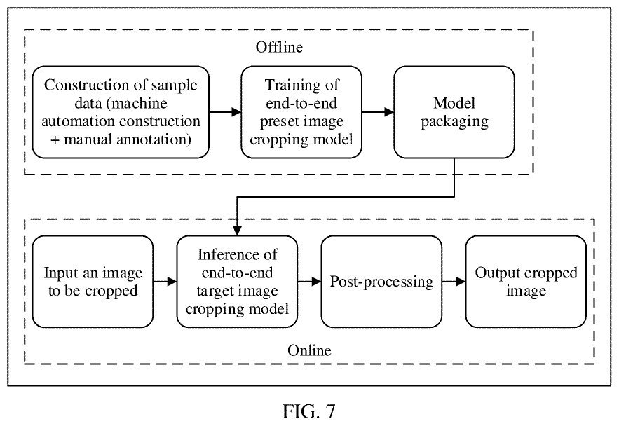

Further, the solution of the present disclosure further provides a complete image cropping system. Specifically, as shown in FIG. 7, the image cropping system in the solution of the present disclosure is divided into offline and online parts:

### (I) Offline Part

The offline part includes construction of the sample data, and training and packaging of the cropping model.

Regarding the construction of the sample data, compared with the related art, the solution of the present disclosure can generate hundreds of thousands of sample data for model training with the same manpower cost.

Regarding the designed target image cropping model, the solution of the present disclosure can effectively avoid problems such as character truncation and text truncation, and can better adapt to multi-size cropping; and moreover, the image cropping model used in the solution of the present disclosure may also be a lightweight model with low deployment cost, and can respond quickly online to process a large quantity of images produced in real time.

### (II) Online Part

Firstly, an image to be cropped published by a target object is received, and the target image cropping model is requested in batches in real time to generate an optimal cropping box on the image to be cropped; secondly, the image to be cropped containing the optimal cropping box is post-processed while face detection and text detection are performed to fine-tune the position of the cropping box in which the character truncation or text truncation may appear; and finally, a complete cropped image without truncation can be obtained, thereby further optimizing the cropping effect.

It should be pointed out that the face detection and text detection are performed during post-processing to judge whether there is any intersection between the cropping box and the face detection box/text detection box. If there is no intersection, a cropped image is produced; if there is an intersection, it indicates that truncation occurs in the current cropping box. At this time, the adjustment may be made using the sliding window or scaling method according to the truncation distance, thereby obtaining a cropping box without character or text truncation, thus further optimizing the cropping effect.

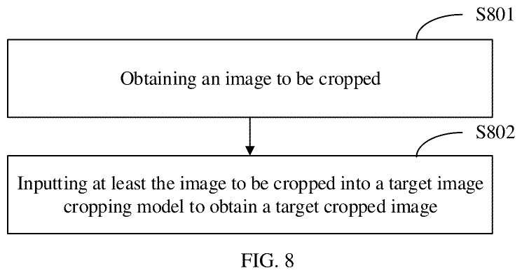

The solution of the present disclosure further provides a method for processing an image. As shown in FIG. 8, the method includes the following steps.

Step S801: an image to be cropped is obtained.

Step S802: the image to be cropped is at least input into a target image cropping model to obtain a target cropped image.

Here, the target image cropping model is obtained based on the method for training the image cropping model described above.

In this way, the cropped image that meets the size requirement in a specific scenario can be obtained using the target image cropping model in the solution of the present disclosure, thus improving the user experience effectively.

Further, in an example, the above step of inputting at least the image to be cropped into the target image cropping model to obtain the target cropped image (for example, the above step S802) may specifically include the following steps.

Step S802-1: target body position information of the image to be cropped is obtained.

Step S802-2: the image to be cropped and the target body position information are input into the target image cropping model to obtain the target cropped image.

The above step of obtaining the target body position information of the image to be cropped may specifically include: inputting the image to be cropped into a target detection model to obtain the target body position information of the image to be cropped. Here, the target detection model is used to detect the position of the target object in the input image.

That is to say, in this example, the target detection model can be used to detect the position of the target body in the image to be cropped to obtain the specific position information of each target body in the image to be cropped (that is, the target body position information described above), so that the model can extract effective features based on the target body position information for use in evaluating the cropped image, thereby providing strong support for improving the cropping accuracy of the model.

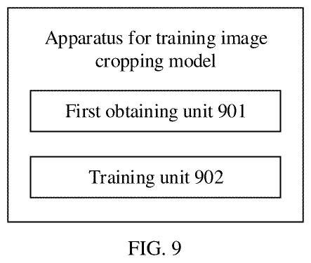

The solution of the present disclosure further provides an apparatus for training an image cropping model, as shown in FIG. 9, including:
a first obtaining unit 901 configured to obtain sample data, where the sample data at least includes: a sample image, a first cropped image obtained by cropping the sample image in a first manner, and a second cropped image obtained by cropping the sample image in a second manner; and
a training unit 902 configured to determine a target loss function, where the target loss function is at least used to: constrain a difference between a first predicted attribute value of the first cropped image and a first theoretical attribute value of the first cropped image, and constrain a difference between a second predicted attribute value of the second cropped image and a second theoretical attribute value of the second cropped image; and configured to use at least the sample data and the target loss function to perform model training on a preset image cropping model to obtain a target image cropping model, where the first predicted attribute value and the second predicted attribute value are obtained using the preset image cropping model.

In a specific example of the solution of the present disclosure, the target loss function is further used for at least one of:
when the sample data includes two or more first cropped images, constraining similarity between a first actual sorting result and a first theoretical sorting result; where the first actual sorting result is a result after sorting all the first cropped images according to numerical values of first predicted attribute values of the first cropped images, and the first theoretical sorting result is a result after sorting all the first cropped images according to numerical values of first theoretical attribute values of the first cropped images; and
when the sample data includes two or more second cropped images, constraining similarity between a second actual sorting result and a second theoretical sorting result; where the second actual sorting result is a result after sorting all the second cropped images according to numerical values of second predicted attribute values of the second cropped images, and the second theoretical sorting result is a result after sorting all the second cropped images according to numerical values of second theoretical attribute values of the second cropped images.

In a specific example of the solution of the present disclosure, the training unit is specifically configured to:
obtain target body position information of the sample image;
input the sample image, the target body position information, the first cropped image and the second cropped image into the preset image cropping model, to obtain the output first predicted attribute value and second predicted attribute value;
obtain a loss value of the target loss function based on the first predicted attribute value and the second predicted attribute value; and
adjust an adjustable parameter in the preset image cropping model based on the loss value, to obtain the target image cropping model.

In a specific example of the solution of the present disclosure, the training unit is specifically configured to:
input the sample image into a target detection model to obtain the output target body position information.

In a specific example of the solution of the present disclosure, the preset image cropping model includes at least a first branch and a second branch;
the first branch is at least used to process a global feature of the sample image and a global feature of the first cropped image to obtain the first predicted attribute value; and
the second branch is at least used to process the global feature of the sample image and a global feature of the second cropped image to obtain the second predicted attribute value.

In a specific example of the solution of the present disclosure, the first branch at least includes a first feature alignment module, a first GAT and a first MLP; where the first feature alignment module is configured to perform feature alignment on the global feature of the sample image and the global feature of the first cropped image; the first GAT is configured to perform attention processing on the sample image and the first cropped image after feature alignment; and the first MLP is configured to perform feature matching on the sample image and the first cropped image after attention processing to obtain the first predicted attribute value;
and/or,
the second branch at least includes a second feature alignment module, a second GAT and a second MLP; where the second feature alignment module is configured to perform feature alignment on the global feature of the sample image and the global feature of the second cropped image; the second GAT is configured to perform attention processing on the sample image and the second cropped image after feature alignment; and the second MLP is configured to perform feature matching on the sample image and the second cropped image after attention processing to obtain the second predicted attribute value.

In a specific example of the solution of the present disclosure, the preset image cropping model further includes a shared backbone network, an output of the shared backbone network serves as inputs of the first branch and the second branch, and the shared backbone network is configured to:
obtain the global feature of the sample image based on the input sample image and the target body position information of the sample image;
obtain the global feature of the first cropped image based on the input first cropped image; and
obtain the global feature of the second cropped image based on the input second cropped image.

In a specific example of the solution of the present disclosure, the first cropped image is obtained by horizontally cropping the sample image;
and/or,
the second cropped image is obtained by vertically cropping the sample image.

For the description of specific functions and examples of the units of the apparatus of the embodiment of the present disclosure, reference may be made to the relevant description of the corresponding steps in the above-mentioned method embodiments, and details are not repeated here.

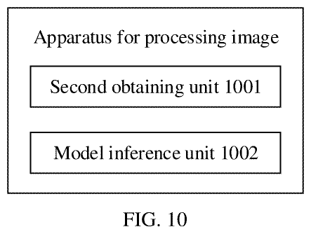

The solution of the present disclosure further provides an apparatus for processing an image, as shown in FIG. 10, including:
a second obtaining unit 1001 configured to obtain an image to be cropped; and
a model inference unit 1002 configured to input at least the image to be cropped into a target image cropping model to obtain a target cropped image, where the target image cropping model is obtained based on the method for training the image cropping model described above.

In a specific example of the solution of the present disclosure, the model inference unit is specifically configured to:
obtain target body position information of the image to be cropped; and
input the image to be cropped and the target body position information into the target image cropping model to obtain the target cropped image.

For the description of specific functions and examples of the units of the apparatus of the embodiment of the present disclosure, reference may be made to the relevant description of the corresponding steps in the above-mentioned method embodiments, and details are not repeated here.

In the technical solution of the present disclosure, the acquisition, storage and application of the user's personal information involved are in compliance with relevant laws and regulations, and do not violate public order and good customs.

According to the embodiments of the present disclosure, the present disclosure also provides an electronic device, a readable storage medium and a computer program product.

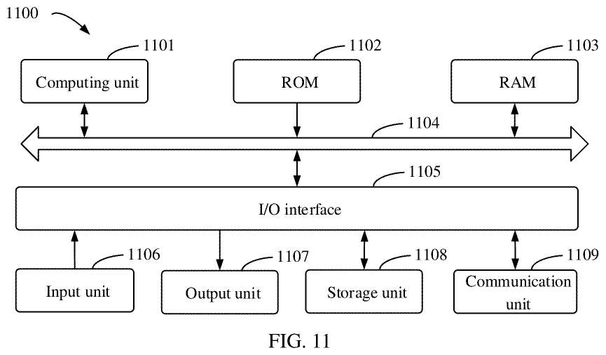

FIG. 11 shows a schematic block diagram of an exemplary electronic device 1100 that may be used to implement the embodiments of the present disclosure. The electronic device is intended to represent various forms of digital computers, such as a laptop, a desktop, a workstation, a personal digital assistant, a server, a blade server, a mainframe computer, and other suitable computers. The electronic device may also represent various forms of mobile devices, such as a personal digital assistant, a cellular phone, a smart phone, a wearable device and other similar computing devices. The components shown herein, their connections and relationships, and their functions are merely examples, and are not intended to limit the implementation of the present disclosure described and/or required herein.

As shown in FIG. 11, the device 1100 includes a computing unit 1101 that may perform various appropriate actions and processes according to a computer program stored in a Read-Only Memory (ROM) 1102 or a computer program loaded from a storage unit 1108 into a Random Access Memory (RAM) 1103. Various programs and data required for an operation of the device 1100 may also be stored in the RAM 1103. The computing unit 1101, the ROM 1102 and the RAM 1103 are connected to each other via a bus 1104. The input/output (I/O) interface 1105 is also connected to the bus 1104.

A plurality of components in the device 1100 are connected to the I/O interface 1105, and include an input unit 1106 such as a keyboard, a mouse, or the like; an output unit 1107 such as various types of displays, speakers, or the like; the storage unit 1108 such as a magnetic disk, an optical disk, or the like; and a communication unit 1109 such as a network card, a modem, a wireless communication transceiver, or the like. The communication unit 1109 allows the device 1100 to exchange information/data with other devices via a computer network such as the Internet and/or various telecommunication networks.

The computing unit 1101 may be various general-purpose and/or special-purpose processing components with processing and computing capabilities. Some examples of the computing unit 1101 include, but are not limited to, a Central Processing Unit (CPU), a Graphics Processing Unit (GPU), various dedicated Artificial Intelligence (AI) computing chips, various computing units that run machine learning model algorithms, a Digital Signal Processor (DSP), and any appropriate processors, controllers, microcontrollers, or the like. The computing unit 1101 performs various methods and processing described above, such as the method for training the image cropping model or the method for processing the image. For example, in some implementations, the method for training the image cropping model or the method for processing the image may be implemented as a computer software program tangibly contained in a computer-readable medium, such as the storage unit 1108. In some implementations, a part or all of the computer program may be loaded and/or installed on the device 1100 via the ROM 1102 and/or the communication unit 1109. When the computer program is loaded into the RAM 1103 and executed by the computing unit 1101, one or more steps of the method for training the image cropping model or the method for processing the image described above may be performed. Alternatively, in other implementations, the computing unit 1101 may be configured to perform the method for training the image cropping model or the method for processing the image by any other suitable means (e.g., by means of firmware).

Various implementations of the system and technologies described above herein may be implemented in a digital electronic circuit system, an integrated circuit system, a Field Programmable Gate Array (FPGA), an Application Specific Integrated Circuit (ASIC), an Application Specific Standard Product (ASSP), a System on Chip (SOC), a Complex Programmable Logic Device (CPLD), a computer hardware, firmware, software, and/or a combination thereof. These various implementations may be implemented in one or more computer programs, and the one or more computer programs may be executed and/or interpreted on a programmable system including at least one programmable processor. The programmable processor may be a special-purpose or general-purpose programmable processor, may receive data and instructions from a storage system, at least one input device, and at least one output device, and transmit the data and the instructions to the storage system, the at least one input device, and the at least one output device.

The program code for implementing the method of the present disclosure may be written in any combination of one or more programming languages. The program code may be provided to a processor or controller of a general-purpose computer, a special-purpose computer or other programmable data processing devices, which enables the program code, when executed by the processor or controller, to cause the function/operation specified in the flowchart and/or block diagram to be implemented. The program code may be completely executed on a machine, partially executed on the machine, partially executed on the machine as a separate software package and partially executed on a remote machine, or completely executed on the remote machine or a server.

In the context of the present disclosure, a machine-readable medium may be a tangible medium, which may contain or store a procedure for use by or in connection with an instruction execution system, device or apparatus. The machine-readable medium may be a machine-readable signal medium or a machine-readable storage medium. The machine-readable medium may include, but is not limited to, an electronic, magnetic, optical, electromagnetic, infrared or semiconductor system, device or apparatus, or any suitable combination thereof. More specific examples of the machine-readable storage medium may include electrical connections based on one or more lines, a portable computer disk, a hard disk, a Random Access Memory (RAM), a Read-Only Memory (ROM), an Erasable Programmable Read-Only Memory (EPROM or a flash memory), an optical fiber, a portable Compact Disc Read-Only Memory (CD-ROM), an optical storage device, a magnetic storage device, or any suitable combination thereof.

In order to provide interaction with a user, the system and technologies described herein may be implemented on a computer that has: a display apparatus (e.g., a cathode ray tube (CRT) or a Liquid Crystal Display (LCD) monitor) for displaying information to the user; and a keyboard and a pointing device (e.g., a mouse or a trackball) through which the user may provide input to the computer. Other types of devices may also be used to provide interaction with the user. For example, feedback provided to the user may be any form of sensory feedback (e.g., visual feedback, auditory feedback, or tactile feedback), and the input from the user may be received in any form (including an acoustic input, a voice input, or a tactile input).

The system and technologies described herein may be implemented in a computing system (which serves as, for example, a data server) including a back-end component, or in a computing system (which serves as, for example, an application server) including a middleware, or in a computing system including a front-end component (e.g., a user computer with a graphical user interface or web browser through which the user may interact with the implementation of the system and technologies described herein), or in a computing system including any combination of the back-end component, the middleware component, or the front-end component. The components of the system may be connected to each other via any form or kind of digital data communication (e.g., a communication network). Examples of the communication network include a Local Area Network (LAN), a Wide Area Network (WAN), and the Internet.

A computer system may include a client and a server. The client and server are generally far away from each other and usually interact with each other via a communication network. A relationship between the client and the server is generated by computer programs running on corresponding computers and having a client-server relationship with each other. The server may be a cloud server, a distributed system server, or a blockchain server.

It should be understood that, the steps may be reordered, added or removed by using the various forms of the flows described above. For example, the steps recorded in the present disclosure can be performed in parallel, in sequence, or in different orders, as long as a desired result of the technical scheme disclosed in the present disclosure can be realized, which is not limited herein.

The foregoing specific implementations do not constitute a limitation on the protection scope of the present disclosure. Those having ordinary skill in the art should understand that, various modifications, combinations, sub-combinations and substitutions may be made according to a design requirement and other factors. Any modification, equivalent replacement, improvement or the like made within the principle of the present disclosure shall be included in the protection scope of the present disclosure.

What is claimed is:

1. A method for training an image cropping model, comprising:
obtaining sample data comprising: a sample image, a first cropped image obtained by cropping the sample image in a first manner, and a second cropped image obtained by cropping the sample image in a second manner;
determining a target loss function, wherein the target loss function is used to:
constrain a difference between a first predicted attribute value of the first cropped image and a first theoretical attribute value of the first cropped image, and
constrain a difference between a second predicted attribute value of the second cropped image and a second theoretical attribute value of the second cropped image; and
using the sample data and the target loss function to perform model training on a preset image cropping model to obtain a target image cropping model, wherein the first predicted attribute value and the second predicted attribute value are obtained using the preset image cropping model.

2. The method of claim 1, wherein using the sample data and the target loss function comprises:
after determining that the sample data comprises two or more first cropped images, constraining similarity between a first actual sorting result and a first theoretical sorting result; wherein the first actual sorting result is a result after sorting all the first cropped images according to numerical values of first predicted attribute values of the first cropped images, and the first theoretical sorting result is a result after sorting all the first cropped images according to numerical values of first theoretical attribute values of the first cropped images; and
after determining that the sample data comprises two or more second cropped images, constraining similarity between a second actual sorting result and a second theoretical sorting result; wherein the second actual sorting result is a result after sorting all the second cropped images according to numerical values of second predicted attribute values of the second cropped images, and the second theoretical sorting result is a result after sorting all the second cropped images according to numerical values of second theoretical attribute values of the second cropped images.

3. The method of claim 1, wherein using the sample data and the target loss function comprises:
obtaining target body position information of the sample image;
inputting the sample image, the target body position information, the first cropped image and the second cropped image into the preset image cropping model, to obtain output comprising first predicted attribute value and second predicted attribute value;
obtaining a loss value of the target loss function based on the first predicted attribute value and the second predicted attribute value; and
adjusting an adjustable parameter in the preset image cropping model based on the loss value, to obtain the target image cropping model.

4. The method of claim 3, wherein obtaining the target body position information of the sample image comprises:
inputting the sample image into a target detection model to obtain output comprising target body position information.

5. The method of claim 1, wherein the preset image cropping model comprises a first branch and a second branch, and wherein:
the first branch is used to process a global feature of the sample image and a global feature of the first cropped image to obtain the first predicted attribute value; and
the second branch is used to process the global feature of the sample image and a global feature of the second cropped image to obtain the second predicted attribute value.

6. The method of claim 5, wherein the first branch comprises a first feature alignment module, a first graph attention network (GAT) and a first multilayer perceptron (MLP); wherein the first feature alignment module is configured to perform feature alignment on the global feature of the sample image and the global feature of the first cropped image; the first GAT is configured to perform attention processing on the sample image and the first cropped image after feature alignment; and the first MLP is configured to perform feature matching on the sample image and the first cropped image after attention processing to obtain the first predicted attribute value;
and/or,
the second branch comprises a second feature alignment module, a second graph attention network (GAT) and a second multilayer perceptron (MLP); wherein the second feature alignment module is configured to perform feature alignment on the global feature of the sample image and the global feature of the second cropped image; the second GAT is configured to perform attention processing on the sample image and the second cropped image after feature alignment; and the second MLP is configured to perform feature matching on the sample image and the second cropped image after attention processing to obtain the second predicted attribute value.

7. The method of claim 5, wherein the preset image cropping model further comprises a shared backbone network, an output of the shared backbone network serves as inputs of the first branch and the second branch, and the shared backbone network is configured to:
obtain the global feature of the sample image based on the sample image and target body position information of the sample image;
obtain the global feature of the first cropped image based on the first cropped image; and
obtain the global feature of the second cropped image based on the second cropped image.

8. The method of claim 1, wherein the first cropped image is obtained by horizontally cropping the sample image;
and/or,
the second cropped image is obtained by vertically cropping the sample image.

9. A method for processing an image, comprising:
obtaining an image to be cropped; and
inputting the image to be cropped into a target image cropping model to obtain a target cropped image, wherein the target image cropping model is obtained based on the method of claim 1.

10. The method of claim 9, wherein inputting the image to be cropped into the target image cropping model comprises:
obtaining target body position information of the image to be cropped; and
inputting the image to be cropped and the target body position information into the target image cropping model to obtain the target cropped image.

11. An electronic device, comprising:
at least one processor; and
a memory connected in communication with the at least one processor;
wherein the memory stores an instruction executable by the at least one processor, and the instruction, when executed by the at least one processor, enables the at least one processor to execute:
obtaining sample data, wherein the sample data comprises: a sample image, a first cropped image obtained by cropping the sample image in a first manner, and a second cropped image obtained by cropping the sample image in a second manner;
determining a target loss function, wherein the target loss function is used to:
constrain a difference between a first predicted attribute value of the first cropped image and a first theoretical attribute value of the first cropped image; and
constrain a difference between a second predicted attribute value of the second cropped image and a second theoretical attribute value of the second cropped image; and
using the sample data and the target loss function to perform model training on a preset image cropping model to obtain a target image cropping model, wherein the first predicted attribute value and the second predicted attribute value are obtained using the preset image cropping model.

12. The electronic device of claim 11, wherein the instruction, when executed by the at least one processor, further enables the at least one processor to execute using the sample data and the target loss function to perform model training, by:
after determining that the sample data comprises two or more first cropped images, constraining similarity between a first actual sorting result and a first theoretical sorting result; wherein the first actual sorting result is a result after sorting all the first cropped images according to numerical values of first predicted attribute values of the first cropped images, and the first theoretical sorting result is a result after sorting all the first cropped images according to numerical values of first theoretical attribute values of the first cropped images; and
after determining that the sample data comprises two or more second cropped images, constraining similarity between a second actual sorting result and a second theoretical sorting result; wherein the second actual sorting result is a result after sorting all the second cropped images according to numerical values of second predicted attribute values of the second cropped images, and the second theoretical sorting result is a result after sorting all the second cropped images according to numerical values of second theoretical attribute values of the second cropped images.

13. The electronic device of claim 11, wherein the instruction, when executed by the at least one processor, further enables the at least one processor to execute using the sample data and the target loss function to perform model training, by:
obtaining target body position information of the sample image;
inputting the sample image, the target body position information, the first cropped image and the second cropped image into the preset image cropping model, to obtain output comprising first predicted attribute value and second predicted attribute value;
obtaining a loss value of the target loss function based on the first predicted attribute value and the second predicted attribute value; and
adjusting an adjustable parameter in the preset image cropping model based on the loss value, to obtain the target image cropping model.

14. The electronic device of claim 13, wherein the instruction, when executed by the at least one processor, further enables the at least one processor to execute obtaining the target body position information of the sample image, by:
inputting the sample image into a target detection model to obtain output comprising target body position information.

15. An electronic device, comprising:
at least one processor; and
a memory connected in communication with the at least one processor,
wherein the memory stores an instruction executable by the at least one processor, and the instruction, when executed by the at least one processor, enables the at least one processor to execute the method of claim 9.

16. A non-transitory computer-readable storage medium storing a computer instruction thereon, wherein the computer instruction is used to cause a computer to execute:
obtaining sample data, wherein the sample data comprises: a sample image, a first cropped image obtained by cropping the sample image in a first manner, and a second cropped image obtained by cropping the sample image in a second manner;
determining a target loss function, wherein the target loss function is used to:
constrain a difference between a first predicted attribute value of the first cropped image and a first theoretical attribute value of the first cropped image; and
constrain a difference between a second predicted attribute value of the second cropped image and a second theoretical attribute value of the second cropped image; and
using the sample data and the target loss function to perform model training on a preset image cropping model to obtain a target image cropping model, wherein the first predicted attribute value and the second predicted attribute value are obtained using the preset image cropping model.

17. The non-transitory computer-readable storage medium of claim 16, wherein the computer instruction is used to further cause the computer to execute: using the sample data and the target loss function to perform model training, by:
after determining that the sample data comprises two or more first cropped images, constraining similarity between a first actual sorting result and a first theoretical sorting result; wherein the first actual sorting result is a result after sorting all the first cropped images according to numerical values of first predicted attribute values of the first cropped images, and the first theoretical sorting result is a result after sorting all the first cropped images according to numerical values of first theoretical attribute values of the first cropped images; and
after determining that the sample data comprises two or more second cropped images, constraining similarity between a second actual sorting result and a second theoretical sorting result; wherein the second actual sorting result is a result after sorting all the second cropped images according to numerical values of second predicted attribute values of the second cropped images, and the second theoretical sorting result is a result after sorting all the second cropped images according to numerical values of second theoretical attribute values of the second cropped images.

18. The non-transitory computer-readable storage medium of claim 16, wherein the computer instruction is used to cause the computer to execute: using the sample data and the target loss function to perform model training, by:
obtaining target body position information of the sample image;
inputting the sample image, the target body position information, the first cropped image and the second cropped image into the preset image cropping model, to obtain output comprising first predicted attribute value and second predicted attribute value;
obtaining a loss value of the target loss function based on the first predicted attribute value and the second predicted attribute value; and
adjusting an adjustable parameter in the preset image cropping model based on the loss value, to obtain the target image cropping model.

19. The non-transitory computer-readable storage medium of claim 18, wherein the computer instruction is used to cause a computer to execute: obtaining the target body position information of the sample image, by:
inputting the sample image into a target detection model to obtain output comprising target body position information.

20. A non-transitory computer-readable storage medium storing a computer instruction thereon, wherein the computer instruction is used to cause a computer to execute the method of claim 9.
